(19) United States
(12) Patent Application Publication
(10) Pub. No.: US 2014/0341334 A1
(43) Pub. Date: Nov. 20, 2014

(54) COMPUTATION APPARATUS, PROGRAM, AND IMAGE PICKUP SYSTEM

(71) Applicant: CANON KABUSHIKI KAISHA, Tokyo (JP)

(72) Inventor: Soichiro Handa, Tokyo (JP)

(73) Assignee: CANON KABUSHIKI KAISHA, Tokyo (JP)

(21) Appl. No.: 14/276,901

(22) Filed: May 13, 2014

(30) Foreign Application Priority Data
May 17, 2013 (JP) 2013-105457
Mar. 31, 2014 (JP) 2014-074066

(51) Int. Cl. G01T 1/17; G01N 23/20

(52) U.S. Cl. CPC G01T 1/17; G01N 23/20075
USPC 378/36; 702/189; 702/199

(57) ABSTRACT

A computation apparatus that calculates subject information by using subject data, includes a calculation unit that calculates spatial distributions of a first-order phase value and a first-order measurement target value by using the subject data, a calculation unit that calculates an error correction function including the first-order phase value as a variable by using information of the spatial distribution of the first-order measurement target value and the spatial distribution of the first-order phase value, and a calculation unit that calculates information of a spatial distribution of a second-order measurement target value corresponding to a spatial distribution obtained by correcting the spatial distribution of the first-order measurement target value by using the error correction function, the information of the spatial distribution of the first-order phase value, and the information of the spatial distribution of the first-order measurement target value.

### BACKGROUND OF THE INVENTION

1. Field of the Invention

The present invention relates to a computation apparatus that calculates information of a subject from a periodic pattern, a program, and an image pickup system.

2. Description of the Related Art

Interferometry extracting information such as a shape of a subject or a refractive index by an analysis on an interference pattern of light is widely used these days. Since phase information of reflected light or transmitted light from the subject is detected as a deformation of the interference pattern in such interferometry, an image of the detected interference pattern is to be analyzed to obtain the phase information. An amount directly calculated by the analysis is generally a phase of the interference pattern at each position (pixel).

The above-described analysis can be performed by not only a one-dimensional pattern such as a so-called vertical stripe or horizontal stripe but also a grid pattern or other two-dimensional patterns. For that reason, a pattern in general which is formed by the interference is referred to as interference pattern in the present invention and the present specification.

It is also possible to calculate a phase of a periodic pattern by using a periodic pattern formed without using the interference instead of the interference pattern. Hereinafter, the analysis on the above-described periodic pattern is referred to as periodic pattern analysis, and a spatial distribution of a phase value of the periodic pattern calculated as a result of the analysis is referred to as phase distribution of the periodic pattern. The periodic pattern includes the interference pattern.

The periodic pattern analysis in the interferometry is generally performed to calculate a phase distribution of subject light, and the phase distribution of subject light is normally derived from the phase distribution of the above-described periodic pattern. However, depending on a method of forming the periodic pattern, useful information related to the subject can be obtained from a spatial distribution of a local average detection value of the light intensity or a distribution of a visibility of the periodic pattern. An example of an interferometer where the information other than the phase distribution of the periodic pattern is thus useful includes a Talbot interferometer based on X-rays or the like.

Meanwhile, a technique widely used these days as a technique for the periodic pattern analysis includes a phase shift method. According to the present technique, a phase of a periodic pattern of an entire view field is relatively shifted to detect the periodic pattern by plural times, and a predetermined calculation using data of the detection result as the input value is performed. According to this, it is possible to calculate the spatial distribution of the phase value, the spatial distribution of the average detection value, the spatial distribution of the periodic pattern visibility, or the like.

According to a basic phase shift method, a phase value or the like is calculated by a calculation on an assumption that a phase shift by an expected amount is accurately performed, and information related to the subject is calculated on the basis of this. In this case, when an error is generated in the phase shift amount due to any factor on an apparatus, an error is also generated in a calculation result. A value of the thus generated error is determined while depending on a wrapped phase values at each position. Thus, the error generally appears in an image as a periodic pattern.

Even in a case where the phase shift by the expected amount is performed or the phase shift method is not used, when an interference pattern is formed by using an interferometer, a similar error may be generated in a case where a profile of the interference pattern strongly contains higher harmonic components in addition to a fundamental wave, for example.

According to J. Schwider, “Phase shifting interferometry: reference phase error reduction” Appl. Opt., Vol. 28, No. 18, 3889-3892 (1989), as an image processing method for correcting the above-described error generated in the spatial distribution of the phase value calculated from the interference pattern, a method of using a function representing a relationship between a tentative calculation value of the phase and the error value on the basis of partial information within the calculation results is described.

According to the error correction method described in J. Schwider, “Phase shifting interferometry: reference phase error reduction” Appl. Opt., Vol. 28, No. 18, 3889-3892 (1989), an error function for correcting the error generated in the spatial distribution of the phase value of the periodic pattern is used. For that reason, the inventor of the present invention finds out that errors generated in the spatial distribution of the average detection value of the periodic pattern and the spatial distribution of the visibility of the periodic pattern may not sufficiently be corrected in some cases.

In view of the above, the present invention provides a computation apparatus in which an effect of a phase shift error or the like with respect to a spatial distribution of an average detection value of a periodic pattern or a spatial distribution of a visibility can be mitigated, a program, and an image pickup system.

### SUMMARY OF THE INVENTION

According to an aspect of the present invention, a computation apparatus that calculates information of a subject by using subject data, in which the subject data is information of a periodic pattern formed by light that has been modulated by the subject, includes a calculation unit configured to calculate a spatial distribution of a first-order phase value and a spatial distribution of a first-order measurement target value by using the subject data, a calculation unit configured to calculate an error correction function including the first-order phase value as a variable by using information of the spatial distribution of the first-order measurement target value and the spatial distribution of the first-order phase value, and a calculation unit configured to calculate information of a spatial distribution of a second-order measurement target value corresponding to a spatial distribution obtained by correcting the spatial distribution of the first-order measurement target value by using the error correction function, the information of the spatial distribution of the first-order phase value, and the information of the spatial distribution of the first-order measurement target value, in which the spatial distribution of the first-order measurement target value is at least one of a distribution of an average detection value and a visibility distribution of the subject data.

Further features of the present invention will become apparent from the following description of exemplary embodiments with reference to the attached drawings.

### BRIEF DESCRIPTION OF THE DRAWINGS

FIG. 1 is a function block diagram of a computation apparatus according to a first exemplary embodiment mode.

FIG. 2 is a schematic diagram of an image pickup system according to the first exemplary embodiment mode.

FIG. 3A is a schematic diagram of a source grating according to the first exemplary embodiment mode.

FIG. 3B is a schematic diagram of a phase grating according to the first exemplary embodiment mode.

FIG. 3C is a schematic diagram of a self image according to the first exemplary embodiment mode.

FIG. 3D is a schematic diagram of a shield grating according to the first exemplary embodiment mode.

FIG. 4 is a flow chart of a series of processings according to the first exemplary embodiment mode.

FIG. 5 is a flow chart of a series of processings according to a second exemplary embodiment mode.

FIG. 6 illustrates a moire used for a simulation according to a first exemplary embodiment.

FIG. 7A illustrates a first-order average detection value distribution obtained according to the first exemplary embodiment.

FIG. 7B illustrates a second-order average detection value distribution obtained according to the first exemplary embodiment.

FIG. 7C illustrates a first-order moire visibility distribution obtained according to the first exemplary embodiment.

FIG. 7D illustrates a second-order moire visibility distribution obtained according to the first exemplary embodiment.

FIG. 8 illustrates a moire used for a simulation according to a second exemplary embodiment.

FIG. 9A illustrates a first-order average detection value distribution obtained according to the second exemplary embodiment.

FIG. 9B illustrates a second-order average detection value distribution obtained according to the second exemplary embodiment.

FIG. 9C illustrates a first-order moire visibility distribution obtained according to the second exemplary embodiment.

FIG. 9D illustrates a second-order moire visibility distribution obtained according to the second exemplary embodiment.

FIG. 10A illustrates an example of subject data used in a simulation according to a third exemplary embodiment.

FIG. 10B illustrates an example of reference data used in the simulation according to the third exemplary embodiment.

FIG. 11A illustrates a first-order average detection value distribution obtained from the subject data according to the third exemplary embodiment.

FIG. 11B illustrates a first-order average detection value distribution obtained from the reference data according to the third exemplary embodiment.

FIG. 11C illustrates a second-order average detection value distribution obtained according to the third exemplary embodiment.

FIG. 12A illustrates a first-order visibility distribution obtained from the subject data according to the third exemplary embodiment.

FIG. 12B illustrates a first-order visibility distribution obtained from the reference data according to the third exemplary embodiment.

FIG. 12C illustrates a second-order visibility distribution obtained according to the third exemplary embodiment.

FIG. 13 is a function block diagram of a computation apparatus according to the second exemplary embodiment mode.

### DESCRIPTION OF THE EMBODIMENTS

Hereinafter, exemplary embodiment modes of the present invention will be described in detail on the basis of the accompanying drawings. In the respective drawings, same components are assigned with same reference numerals, and a redundant description will be omitted.

As described above, according to the error correction method described in J. Schwider, “Phase shifting interferometry: reference phase error reduction” Appl. Opt., Vol. 28, No. 18, 3889-3892 (1989) (hereinafter, which will be referred to as Non-Patent Document 1), it is supposed that an error generated in the phase distribution of the periodic pattern is corrected. A sine wave component having a period that is ½ of the periodic pattern is dominant in the error generated in the phase distribution in many cases. In view of the above, according to Non-Patent Document 1, when the tentatively obtained phase value is set as Φ′, the error is represented by a function including a term that can be represented as A sin(2Φ′+α) (A and α are constants).

However, the inventor of the present invention finds out that the errors generated in the average detection value and the visibility are different from the error generated in the phase distribution in that the sine wave component having a same fundamental period as the fundamental period of the periodic pattern is intensively contained and the error value is not to be estimated at a sufficient accuracy only from the tentative phase value.

In view of the above, the image pickup system according to the present exemplary embodiment mode is provided with a computation apparatus that can reduce the errors that are generated in the average detection value and the visibility. Although a detail of the computation apparatus will be described below, the computation apparatus calculates an error correction function on the basis of an image pickup result of an image pickup system and corrects the errors generated in the distribution of the average detection value of the subject and the distribution of the visibility by using this error correction function. This error correction function is calculated from the information of the first-order phase value corresponding to the tentative calculation of the phase of the periodic pattern and the information of the first-order measurement target value corresponding to the tentative calculation of the measurement target value and includes the first-order phase value and the first-order measurement target value as the variables. Since the error correction function includes the first-order phase value as the variable, it is possible to perform the error correction at a higher accuracy as compared with the error correction function that does not include the first-order phase value as the variable. For example, in an error correction for adding a certain tilt or a curvature factor to the distribution of the first-order measurement target value, the periodic error or the like that depends on the phase of the interference pattern is not corrected at a high accuracy in general. The first-order measurement target value corrected by using the error correction function in the above-described manner may be referred to as second-order measurement target value in the present specification.

The measurement target value refers to a value of a calculation target by the computation apparatus and is at least one of the average detection value of the periodic pattern and the visibility. Since the spatial distributions of these values include periodic measurement errors derived from the phase shift error, the higher harmonic component, or the like, it is possible to reduce the errors generated in the average detection value or the visibility by correcting the first-order measurement target distribution by using the error correction function.

In a case where both the average detection value and the visibility are set as the measurement target values, the error correction function calculated from information of the spatial distribution of the first-order average detection value and the spatial distribution of the first-order phase value is used for the correction of the error of the average detection value distribution. The error correction function calculated from information of the spatial distribution of the first-order visibility value and the spatial distribution of the first-order phase value is used for the correction of the error of the visibility distribution.

In the present invention and the present specification, the image pickup is not limited to the obtainment of the image, and it is also regarded as the image pickup to obtain information related to the subject at each of a plurality of positions. For example, when an apparatus obtains an average detection value at a first position and an average detection value at a second position (which is set as a different position from the first position), the apparatus is regarded as the image pickup apparatus.

The computation apparatus can be constituted by a computer including a central processing unit (CPU), a main storage apparatus (a RAM or the like), an auxiliary storage apparatus (an HDD, an SSD, or the like), and various interfaces. Various computations performed by the computation apparatus are realized when programs stored in the auxiliary storage apparatus are loaded to the main storage apparatus and executed by the CPU. Of course, this configuration is merely an example and is not intended to limit the scope of the present invention. For example, instead of the auxiliary storage apparatus, the programs may be loaded to the main storage apparatus via a network or various storage apparatuses.

The error correction function may be calculated by using subject data or may also be calculated by using the reference data. In the present invention and the present specification, the subject data is information of the periodic pattern formed by the light that has been modulated by the subject. This subject data can be obtained while an intensity distribution of the periodic pattern formed on the detector when the subject is arranged in an optical path between the light source and the detector of the image pickup apparatus provided to the image pickup system. On the other hand, the reference data is information of the periodic pattern formed by the light that has not been modulated by the subject. This reference data can be obtained while an intensity distribution of the periodic pattern formed on the detector when the subject is not arranged in the optical path between the light source and the detector of the image pickup apparatus provided to the image pickup system. At this time, an object other than the subject may be arranged in the optical path, but the optical characteristic of the object arranged in the optical path is preferably already found out, or a size of the arranged object is preferably small with respect to an image pickup range.

A case of calculating the error correction function by using the subject data will be described according to a first exemplary embodiment mode, and a case of calculating the error correction function by using the reference data will be described according to a second exemplary embodiment mode.

### First Exemplary Embodiment Mode

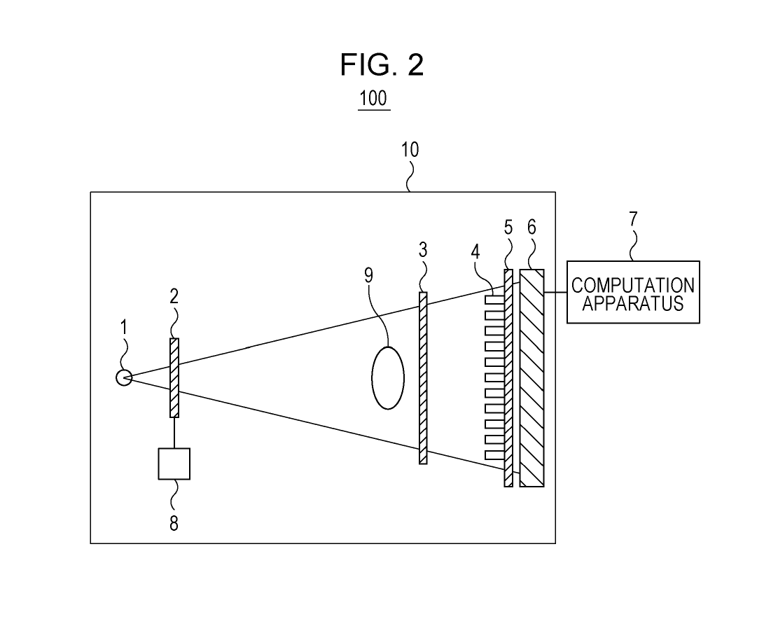

FIG. 2 illustrates a configuration example of an image pickup system 100 according to the first exemplary embodiment mode of the present invention. The present image pickup system 100 is an X-ray image pickup system that uses X-rays as light and is provided with an image pickup apparatus 10 that performs an X-ray Talbot-Lau interferometry and a computation apparatus 7. In the present specification, the description will be given while the X-ray is also regarded as a part of the light. Herein, the X-ray is set as an electromagnetic ray having photon energy that is higher than or equal to 2 keV and lower than or equal to 100 key. In addition, as the image pickup apparatus 10 provided to the image pickup system 100, an image pickup apparatus that performs interferometry other than the Talbot-Lau interferometry may be used, and also an image pickup apparatus other than the interferometer may also be used so long as the periodic pattern can be formed. An apparatus that performs Talbot-Lau interferometry is referred to as Talbot-Lau interferometer. This is a type of the Talbot interferometer corresponding to the image pickup apparatus that performs the Talbot interferometry. The image pickup apparatus 10 will simply be described.

The image pickup apparatus 10 includes an X-ray source 1, a source grating 2 that virtually divides the X-ray source 1, a phase grating 3 that diffracts the X-ray to form an interference pattern, a shield grating 5 that shields a part of the interference pattern, a detector 6 detects the X-ray from the shield grating 5, and a positioning stage 8 that moves the source grating 2.

The X-ray output from the X-ray source 1 passes through the source grating 2 and forms a large number of virtual linear X-ray sources. The X-ray output from the linear X-ray sources constituted by transmission units of the source grating 2 transmits through the subject 9, and the phase and the intensity are changed in accordance with the composition, density, shape, and the like of the subject 9. The X-ray where the phase and the intensity are changed by the subject transmits through the phase grating 3 to be diffracted, and a self image having a periodic intensity distribution due to Talbot effects is formed. This self image is one type of interference patterns and is formed by the transmitted X-ray of the subject 9. For that reason, the self image is transformed by reflecting the changes in the phase and the intensity of the X-ray by the subject 9. A period of the transmission units of the source grating 2 is determined while following a certain rule. Since the self images formed by all the virtual linear X-ray sources are overlapped with each other while being shifted by integral multiples of the period of the self image, it is possible to form a self image 4 having relatively high visibility and X-ray intensity at the time same. An amplitude type diffraction grating may also be used instead of the phase grating 3 corresponding to a phase-type diffraction grating.

The shield grating 5 is arranged at a position where the self image 4 is formed. The shield grating 5 has the same period as the self image 4. When the shield grating 5 is subjected to an in-plane rotation with respect to the self image 4, the X-ray that has transmitted through the shield grating 5 can form a moire. This moire is detected by the detector 6, and the computation apparatus 7 calculates the information of the subject on the basis of this detection information. To elaborate, according to the present exemplary embodiment mode, the moire formed by the X-ray that has transmitted through the shield grating 5 is a periodic pattern subjected to a periodic pattern analysis, and the phase grating 3 and the shield grating 5 are optical elements that form the periodic pattern. Since a period of the moire changes depending on a relative rotation angle between the self image and the shield grating 5, the period of the moire can be adjusted by changing the in-plane rotation amount of the shield grating 5. In addition, the moire may also be formed by slightly changing the period of the self image and the period of the shield grating 5 instead of performing in-plane rotation of the shield grating 5 with respect to the self image. In FIG. 2, the subject is arranged between the source grating 2 and the phase grating 3, but the subject may also be arranged between the phase grating 3 and the shield grating 5. In that case, when the X-ray diffracted by the phase grating 3 transmits through the subject, the self image reflecting the changes in the phase and the intensity of the X-ray by the subject 9 is formed on the shield grating 5.

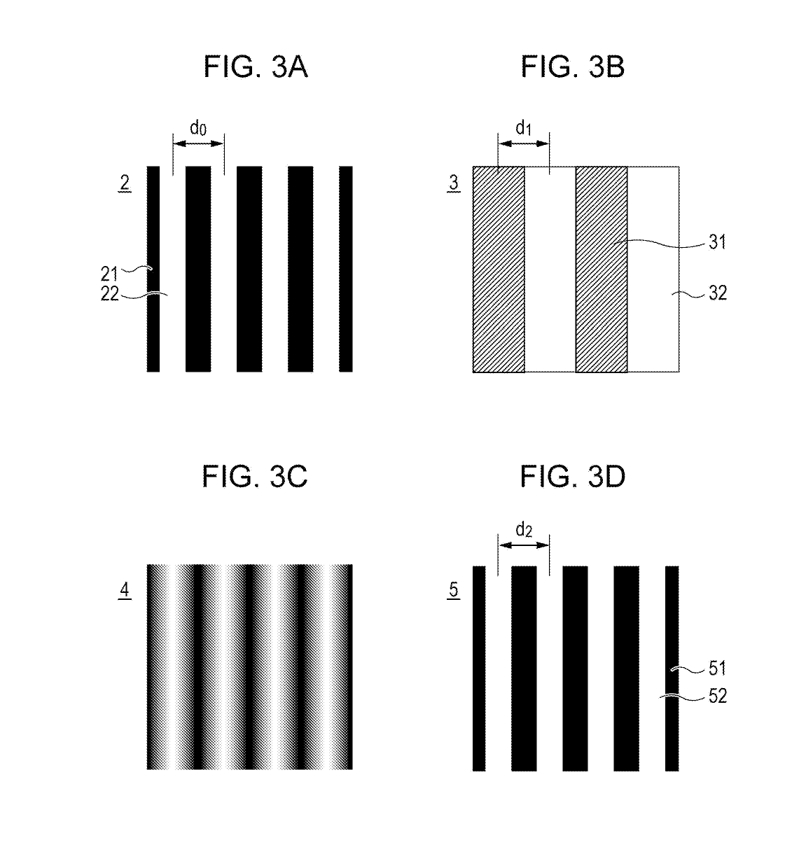

FIGS. 3A to 3D respectively illustrate pattern examples of the source grating 2, the phase grating 3, the self image 4 of the phase grating 3 which is formed by the optical system, and the shield grating 5. It is noted that the Talbot interferometer using a one-dimensional grating having a period in one direction will be described herein, but a two-dimensional grating having periods in two directions may be used. FIG. 3A illustrates the source grating 2 in which a black part corresponds to an X-ray shielding part 21, and a colorless part corresponds to an X-ray transmission part 22. FIG. 3B illustrates the phase grating 3 in which a hatched part corresponds to a phase advance part 31, and a non-hatched part corresponds to a phase delay part 32. Herein, the X-ray that has transmitted through the phase advance part 31 has a phase advanced by πrad with respect to the X-ray that has transmitted through the phase delay part 32. An X-ray transmission factor difference between the phase advance part 31 and the phase delay part 32 is set to be sufficiently small. FIG. 3C illustrates the self image 4 in which it is represented that a part closer to the colorless part has a higher X-ray intensity, and a part closer to the black part has a lower X-ray intensity. FIG. 3D illustrates the shield grating 5 in which the black part corresponds to an X-ray shielding part 51, and the colorless part corresponds to an X-ray transmission part 52.

Since the phase of the moire pattern relies on a relative positional relationship between the self image and the shield grating 5, the phase shift method can be performed by performing an in-plane translation of the self image. Herein, the phase shift method is performed by performing a translation in the periodic direction of the source grating 2 by the positioning stage 8 and relatively shifting the phase of the moire pattern of the entire view field to perform the detection by plural times. The thus detected plural pieces of moire information (to elaborate, the subject data) are transmitted to the computation apparatus 7 connected to the detector 6, and the information of the subject is calculated from a change in the detection values between the plural pieces of the subject data.

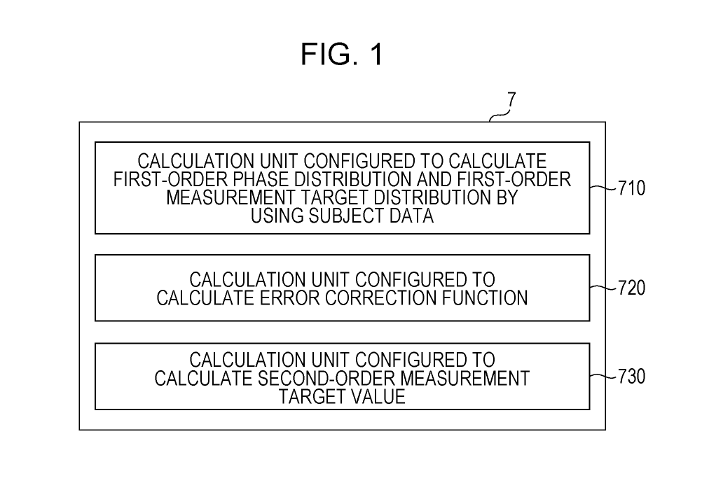

FIG. 1 is a function block diagram of the computation apparatus 7 according to the present exemplary embodiment mode.

The computation apparatus 7 includes a calculation unit 710 (which may be referred to as first calculation unit) configured to calculate a spatial distribution of the first-order phase value (which may be referred to as first-order phase distribution) and a spatial distribution of the first-order measurement target value (which may be referred to as the first-order measurement target distribution) by using the subject data. The computation apparatus 7 further includes a calculation unit 720 (which may be referred to as second calculation unit) configured to calculate an error correction function and a calculation unit 730 (which may be referred to as third calculation unit) configured to calculate a second-order measurement target value. Hereinafter, the respective calculation units will be described.

The first calculation unit subjects the subject data to a periodic pattern analysis to calculate the first-order phase distribution and the first-order measurement target distribution. Any method for the periodic pattern analysis may be employed. The distribution of the visibility of the moire in the X-ray Talbot interferometer reflects the distribution of the X-ray small-angle scattering power distribution of the subject, and the distribution of the average detection value reflects the X-ray transmittance distribution of the subject.

The second calculation unit calculates the error correction function by using the information of the spatial distribution of the first-order measurement target value and the spatial distribution of the first-order phase value. To elaborate, the error correction function calculated from the information of the distribution of the first-order average detection value (which may be referred to as first-order average detection value distribution) and the first-order phase distribution is used for the correction on the error of the average detection value distribution. The error correction function calculated from the information of the distribution of the first-order visibility value (which may be referred to as first-order visibility distribution) and the first-order phase distribution is used for the correction on the error of the visibility distribution. These pieces of information used for calculating the error correction function preferably correspond to a same area of the periodic pattern. For example, when the periodic pattern has an area denoted by A, the error correction function is preferably calculated by using the information of the first-order measurement target distribution and the information of the first-order phase distribution which are calculated from this area A.

This error correction function calculated by the second calculation unit is a function for outputting the second-order measurement target value corresponding to the measurement target value after the error correction in which the first-order measurement target value is set as an input value. This error correction function includes the first-order phase value as the variable. The first-order measurement target value and the first-order phase value used for the calculation of the error correction function are preferably the measurement target value and the phase value in the area where a manner of the change in the periodic pattern is already found out. For that reason, for example, the error correction function is preferably calculated from the first-order measurement target value and the first-order phase value of an area where the X-ray that has transmitted through an outer side of the subject forms the periodic pattern, to elaborate, an area where the X-ray that has reached the detector without transmitting through the subject in the periodic pattern forms the detection intensity distribution. In this manner, the area detected without substantially receiving the influence from the subject in the subject data is referred to as blank area in the present specification.

For example, various data analysis methods such as a method of using curvature fitting to the measured error pattern can be used for the calculation of the error correction function. In addition, a trigonometric function or the like for representing the error correction function can be used. An error having a period that is ½ of a fundamental period of the periodic pattern is easily generated in the phase distribution, but an examination conducted by the inventor of the present invention finds out that an error having a same period as the fundamental period of the periodic pattern is also easily generated in the average detection value distribution and the visibility distribution. For that reason, the error correction function calculated by the second calculation unit can preferably correct the error of the same period as the fundamental period of the periodic pattern. Thus, the error correction function preferably has a term that can be represented, for example, as A sin(Φ′+α) (A and α are a constant) when the first-order phase value is set as Φ′. In the present invention and the present specification, the calculation of the error correction function also includes obtaining the error correction function by assigning a value to a predetermined function. For example, an assignment of a value or a function determined on the basis of the analysis result in the blank area to an undecided coefficient in a function previously stored in the auxiliary storage apparatus is also regarded as the calculation of the error correction function. Moreover, for example, a determination on a coefficient in a function by referring to a table representing a relationship between the calculation result by the first calculation unit and the coefficient in the function is also regarded as the calculation of the error correction function.

The third calculation unit calculates the spatial distribution of the second-order measurement target value (hereinafter, which may be described as second-order measurement target distribution) by using the error correction function calculated by the second calculation unit and the first-order measurement target distribution and the first-order phase distribution calculated by the first calculation unit. Specifically, the first-order phase distribution and the first-order measurement target distribution are assigned to the error correction function calculated by the second calculation unit to calculate the spatial distribution of the second-order measurement target value. That is, the first-order phase value and the first-order measurement target value are assigned to the error correction function to calculate the second-order measurement target value for a plurality of coordinate systems, so that the spatial distribution of the second-order measurement target value is calculated. In the present invention and the present specification, the operation in which the assignment of the first-order phase value and the first-order measurement target value is performed for the plurality of coordinate systems in the above-described manner refers to the assignment of the first-order phase distribution and the first-order measurement target distribution.

According to the present exemplary embodiment mode, by assigning the first-order phase distribution and the first-order measurement target distribution in the entire area of the subject data to the variable parts of the error correction function calculated by using the first-order phase distribution and the first-order measurement target distribution in the partial area of the subject data, the second-order measurement target distribution in the entire area of the subject data is calculated. According to the present exemplary embodiment mode, this second-order measurement target distribution is the final subject information calculated by the computation apparatus 7, but the computation apparatus 7 may further perform various computations with respect to the second-order measurement target distribution. In a case where the second-order measurement target distribution is set as the final subject information, the calculation result calculated by the third calculation unit may be transmitted to an image display apparatus connected to the computation apparatus or transmitted to the auxiliary storage apparatus to be stored in the auxiliary storage apparatus.

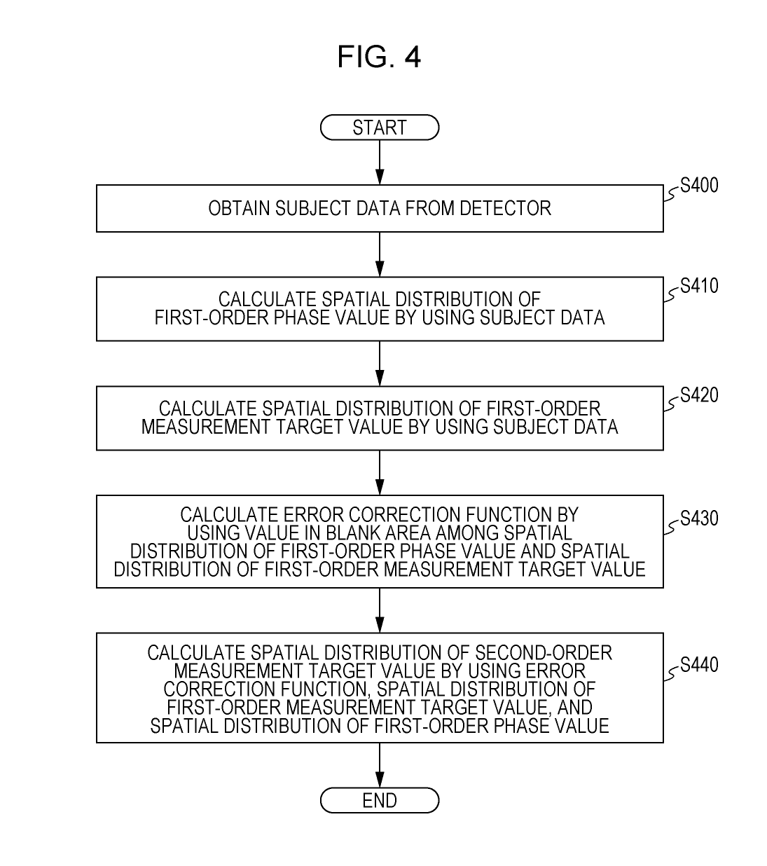

FIG. 4 is a flow chart for computation processing procedures performed by the computation apparatus according to the present exemplary embodiment mode.

First, the computation apparatus obtains the subject data from the detector (S400). The detector and the computation apparatus may not physically be connected to each other in adjacent positions and may be connected to each other via a wireless communication, a LAN, the internet, or the like. Next, the first-order phase distribution is calculated (S410). Subsequently, the first-order measurement target distribution is calculated (S420). Then, the error correction function is calculated by using the spatial distribution in the blank area among the first-order measurement target distribution and the first-order phase distribution (S430). Then, by using the calculated error correction function, the first-order measurement target distribution, and the first-order phase distribution, the second-order measurement target distribution is calculated (S440).

This flow may not be carried out in the above-described order. For example, 5420 may be carried out before 5410.

### Second Exemplary Embodiment Mode

A computation apparatus according to the second exemplary embodiment mode is different from the computation apparatus according to the first exemplary embodiment mode in that the error correction function is calculated by using the reference data instead of the blank area of the subject data.

The present exemplary embodiment mode is an effective exemplary embodiment mode in a case where an error generation factor has a repeatability. As an example of the above-described case, a case in which a phase shift error has a certain repeatability due to a reason in terms of the apparatus, a case in which the detected periodic pattern includes certain higher harmonic components, and the like are conceivable. Since the image pickup system according to the present exemplary embodiment mode is the same as the first exemplary embodiment mode except for the computation processing performed by the computation apparatus, the description of the redundant part will be omitted.

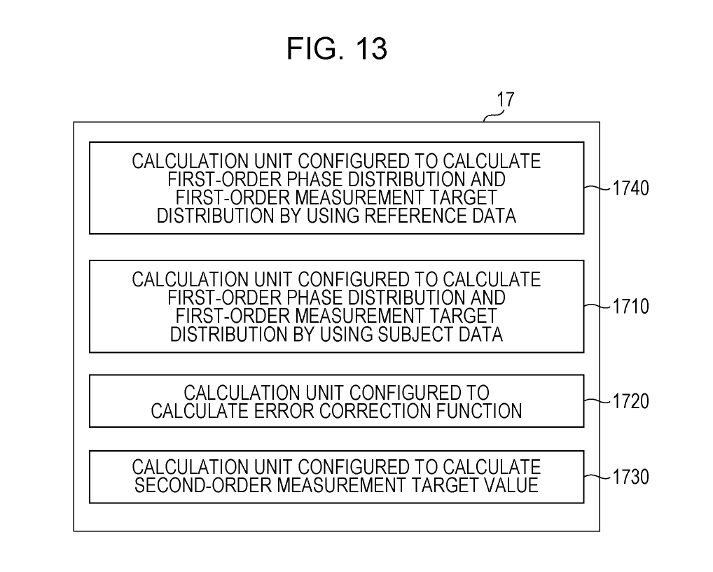

FIG. 13 is a function block diagram of a computation apparatus 17 according to the present exemplary embodiment mode.

The computation apparatus 17 has the calculation unit configured to calculate the first-order phase distribution and the first-order measurement target distribution by using the subject data, the calculation unit configured to calculate the error correction function, and the calculation unit configured to calculate the second-order measurement target value similarly as in the computation apparatus 7 according to the first exemplary embodiment mode. In addition to these calculation units, the computation apparatus 17 according to the present exemplary embodiment mode further includes a calculation unit configured to calculate the first-order phase distribution and the first-order measurement target distribution from the reference data (which may be referred to as fourth calculation unit). The calculation unit configured to calculate the error correction function is different from the first exemplary embodiment mode in that the error correction function is calculated by using the information of the first-order phase value and the first-order measurement target value calculated from the reference data.

Hereinafter, the respective calculation units will be described.

Since a calculation unit 1710 (first calculation unit) configured to calculate the first-order phase distribution and the first-order measurement target distribution from the subject data calculates the first-order phase distribution and the first-order measurement target distribution from the subject data similarly as in the first calculation unit 710 according to the first exemplary embodiment mode, a detail thereof will be omitted.

A calculation unit 1720 (second calculation unit) configured to calculate the error correction function calculates the error correction function by using the information of the spatial distribution of the first-order measurement target value and the spatial distribution of the first-order phase value calculated by using the reference data. As is different from the first exemplary embodiment mode, in a case where the first-order measurement target value and the first-order phase value calculated by using the reference data are used, the error correction function may be calculated by using the information of the entire first-order measurement target distribution and the entire first-order phase distribution. This is because, since the reference data does not include the information of the subject, a manner of a change in the periodic pattern can already be found out in the entire reference data. The spatial distribution of the first-order measurement target value and the spatial distribution of the first-order phase value are calculated by the fourth calculation unit which will be described below. Although the information used for the calculation of the error correction function varies, the calculation method of the error correction function, the representation, and the like are similar to the first exemplary embodiment mode. For example, various data analysis techniques such as a technique using the curvature fitting to the measured error pattern can be used for the calculation of the error correction function. The error correction function is calculated by using the first-order measurement target value and the first-order phase value calculated by using the reference data. In the calculated error correction function, the first-order measurement target value and the first-order phase value indicate the first-order measurement target value and the first-order phase value of the general periodic pattern obtained by using the same apparatus. To elaborate, when the first-order measurement target value and the first-order phase value calculated by using the data of the general periodic pattern are assigned to the first-order measurement target value and the first-order phase value included as the variables in the error correction function calculated by using the reference data, the error of the assigned first-order measurement target value can be corrected. The subject data is included in the data of the general periodic pattern. To elaborate, when the first-order measurement target value and the first-order phase value calculated by using the subject data are assigned to the first-order measurement target value and the first-order phase value included in the error correction function calculated by using the reference data as the variables, it is possible to correct the error of the subject information.

The error correction function preferably has a term that includes the first-order phase value as the variable and can be represented, for example, as A sin(Φ′+α) (A and α are a constant) when the first-order phase value is set as Φ′.

A calculation unit 1730 (third calculation unit) configured to calculate the second-order measurement target calculates the second-order measurement target distribution by using the error correction function calculated in the second calculation unit and the first-order measurement target distribution and the first-order phase distribution calculated in the first calculation unit. Since the third calculation unit is also similar to the third calculation unit according to the first exemplary embodiment mode, a detail thereof will be omitted.

A calculation unit (fourth calculation unit) 1740 configured to calculate the first-order phase distribution and the first-order measurement target distribution from the reference data performs the periodic pattern analysis of the reference data to calculate the first-order phase distribution and the first-order measurement target distribution. The first-order measurement target distribution and the first-order phase distribution corresponding to the entire reference data may be calculated, and the first-order measurement target distribution and the first-order phase distribution corresponding to only an area used for the calculation of the error correction function among the reference data may also be calculated.

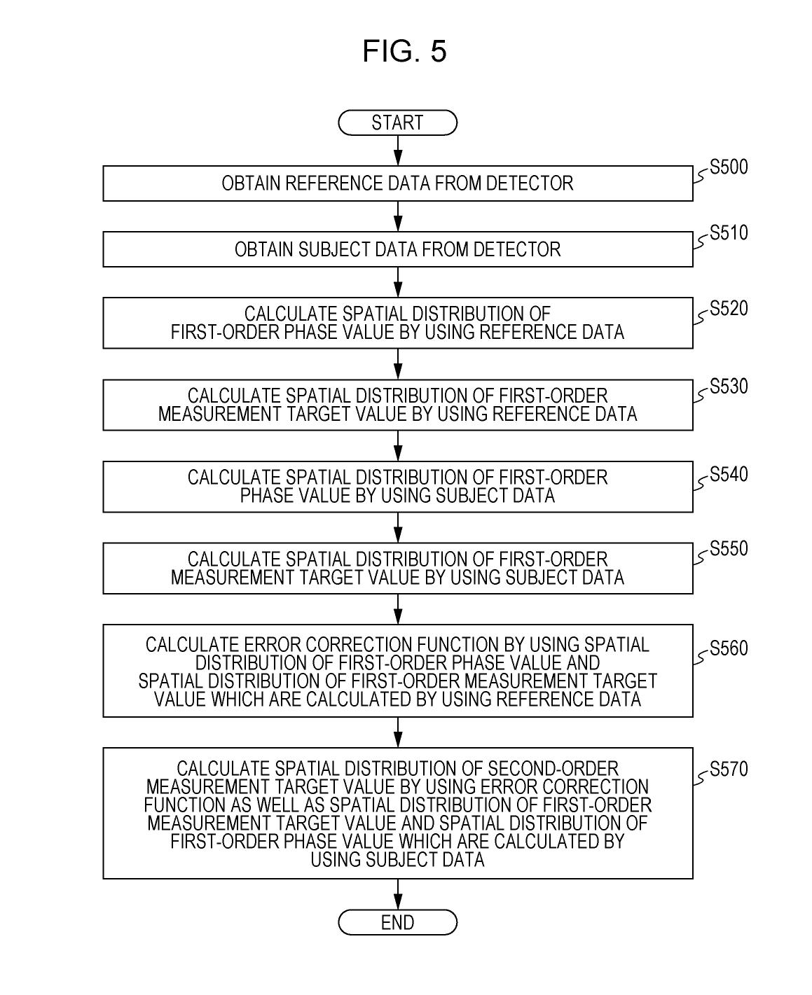

FIG. 5 is a flow chart of computation processing procedures performed by the computation apparatus 17 according to the present exemplary embodiment mode.

The computation apparatus 17 first obtains the reference data from the detector (S500). Next, the subject data is obtained from the detector (S510). Then, the first-order phase distribution is calculated by using the reference data (S520). Subsequently, the first-order measurement target is calculated by using the reference data (S530). Next, the first-order phase distribution is calculated by using the subject data (S540). After that, the first-order measurement target distribution is calculated by using the subject data (S550). Next, the error correction function is calculated by using the first-order measurement target distribution and the first-order phase distribution calculated by using the reference data (S560). The first-order measurement target distribution and the first-order phase distribution calculated by using the subject data are assigned to the calculated error correction function, so that the second-order measurement target distribution is calculated (S570). This flow may not be carried out in the above-described order. For example, 5520 may be carried out before 5510.

According to the present exemplary embodiment mode, the reference data is obtained separately from the subject data. According to this, since the error correction function can be calculated without creating the blank area in the subject data, it is possible to perform the image pickup of the subject in a state in which the subject exists in the entire image pickup area. In general, at the time of the measurement by the interferometer, before or after the subject data is obtained, the data that does not include the subject used for the error correction derived from the incompleteness of the optical element or the like from the measurement result is often obtained, but such data may be used as the reference data.

Hereinafter, more specific embodiments of the respective exemplary embodiment modes will be described.

### First Exemplary Embodiment

A first exemplary embodiment is a specific embodiment of the first exemplary embodiment mode.

The X-ray source 1 is an X-ray source using a molybdenum target, and a generated X-ray has an energy spectrum having a peak of a characteristic X-ray at a position of 17.5 key. The patterns of the source grating 2, the phase grating 3, the shield grating 5 similar to those illustrated in FIGS. 3A, 3B, and 3D. The X-ray shielding part of the source grating 2 is formed of gold having a thickness of 50.0 μm, a period d₀ is set as 23.6 μm, and a slit width of the X-ray transmission part is set as 11.8 μm. The phase grating 3 is made of silicon, and a center distance d₁ between the adjacent the phase advance part and the phase delay is set as 6.00 μm. A thickness of the phase advance part of the phase grating 3 is thicker than the phase delay part by 22.3 μm, and with this setting, it is possible to provide a phase difference of πrad with respect to the transmitted X-ray at 17.5 keV. The X-ray shielding part of the shield grating 5 is formed of gold having a thickness of 50.0 μm, a period d₂ is set as 8.04 μm, and a slit width of the X-ray transmission part is set as 4.02 μm. A distance L₁ between the source grating 2 and the phase grating 3 is set as 1.00 m, and a distance L₂ between the phase grating 3 and the shield grating 5 is set as 341 mm.

According to the first exemplary embodiment, the periodic pattern analysis based on the 3-step phase shift method is performed. With the slight in-plane rotation of the shield grating 5, the period of the moire detected by the detector 6 is adjusted to have an appropriate length shorter than a width of the detection area.

The phase shift method used according to the first exemplary embodiment will be described below. Herein, for simplicity, the moire is represented by a single sign wave. At this time, a detection value Iₙ in a pixel in the moire image detected in the n-th turn in the phase shift method is represented as follows.

Iₙ=I₀[1+V cos(Φ+φₙ)] (1)

Where I₀ denotes an average detection value, V denotes the visibility of the moire, and φₙ denotes the phase shift value of the moire in the n-th moire. Φ denotes the phase value of the moire at the time of φₙ=0. It is however noted that the phase value of the moire refers to one where the periodic pattern is a moire among the phase values of the periodic pattern.

According to the present phase shift method, the phase shift while 2π/3 is set as one unit is performed, and the moire detection is performed by three times in total. That is, the phase shift of the moire is carried out as in the following expression (2).

$${ϕ}_{n} = 0 , \frac{2 π}{3} , \frac{4 π}{3} ; n = 1 , 2 , 3 \qquad ( 2 )$$

At this time, the first-order average detection value is set as I₀′, the first-order moire phase value at the time of φₙ=0 is set as Φ′, and the first-order visibility value is set as V′, these can respectively be calculated by using the following expressions (3) to (5).

$$\begin{matrix}{I}_{0}^{′} = \frac{1}{3} {\sum }_{k = 1}^{3} {I}_{k} & ( 3 ) \\ {Φ}^{′} = arg [ {\sum }_{k = 1}^{3} {I}_{k} exp ( - 2 π i \frac{k - 1}{3} ) ] & ( 4 ) \\ {V}^{′} = 2 \frac{\vert {\sum }_{k = 1}^{3} {I}_{k} exp ( - 2 π i \frac{k - 1}{3} ) \vert}{{\sum }_{k = 1}^{3} {I}_{k}} & ( 5 )\end{matrix}$$

When φₙ does not have an error, that is, the condition is as represented by the expression (2), I₀′=I₀, Φ′=Φ, and V′=V are established. It is however noted that the actually calculated Φ′ is a wrapped phase.

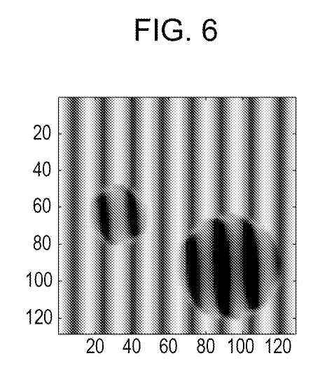

FIG. 6 illustrates a moire used for a simulation according to the present exemplary embodiment. This moire is created by supposing the moire obtained by the above-described interferometer. Herein, a spherical object is supposed as the subject 9.

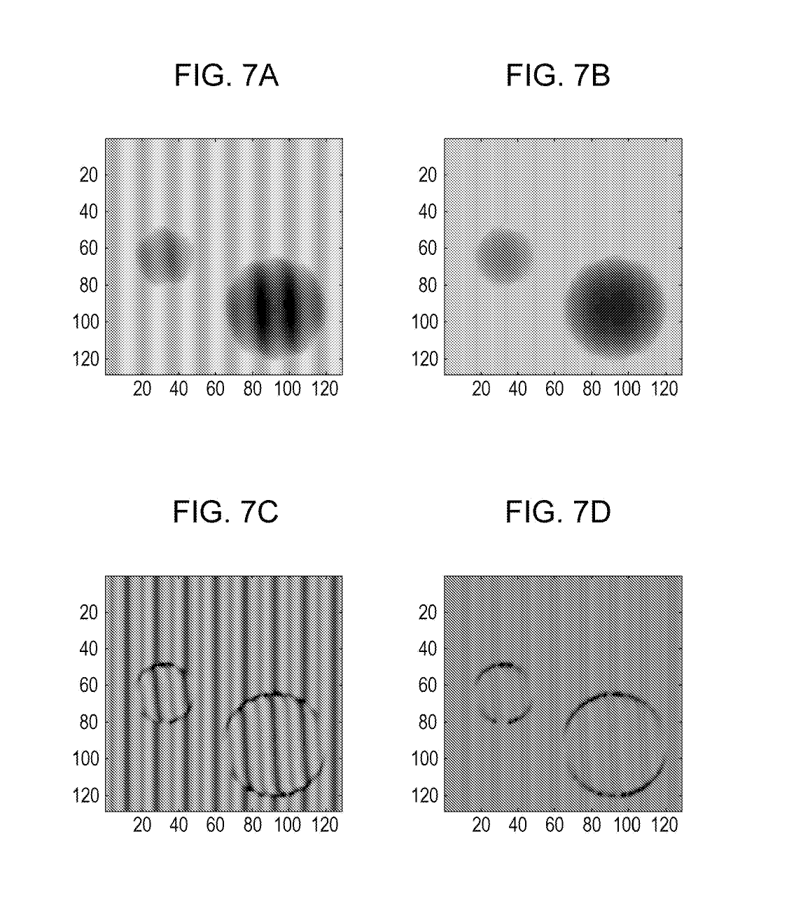

FIGS. 7A and 7C illustrate images of the first-order average detection value I₀′ and the first-order visibility V′ calculated by the first calculation unit by using the subject data accompanying three phase shifts in total including FIG. 6 and the expressions (3) and (5). These images illustrated in FIGS. 7A and 7C are images based on the spatial distribution of the first-order measurement target value. FIG. 7A illustrates the image based on the spatial distribution of the first-order average detection value I₀′, and FIG. 7C illustrates the image based on the spatial distribution of the first-order visibility V′. The periodic patterns as seen in FIGS. 7A and 7C are derived from the phase shift errors intentionally provided at the time of the simulations.

FIGS. 7B and 7D illustrate results of computation processing using the error correction function on FIGS. 7A and 7C corresponding to the images of the spatial distribution of the first-order measurement target value. To elaborate, FIGS. 7B and 7D illustrate images based on the spatial distribution of the second-order measurement target value calculated by the third calculation unit. According to the present exemplary embodiment, the error correction function is calculated by the second calculation unit by using information of the spatial distribution of the first-order measurement target value and the spatial distribution of the first-order phase value Φ′ in the blank area corresponding to an upper right part in FIG. 6. Then, the first-order measurement target distribution and the first-order phase distribution are assigned to the calculated error correction function to calculate the second-order measurement target distribution. The error correction function used herein is a function for dividing the first-order measurement target value by a value determined by the first-order phase value and can be represented by the following expressions (6) and (7) when the second-order average detection value after the error correction is set as I₀″, and the second-order visibility after the error correction is set as V″.

$$\begin{matrix}{I}_{0}^{″} = \frac{{I}_{0}^{′}}{1 + {\sum }_{k = 1}^{4} {a}_{{I}_{0 , k}^{′}} cos ( k {Φ}^{′} + {ψ}_{{I}_{0}^{′} , k} )} & ( 6 ) \\ {V}^{″} = \frac{{V}^{′}}{1 + {\sum }_{k = 1}^{4} {a}_{{V}^{′} , k} cos ( k {Φ}^{′} + {ψ}_{{V}^{′} , k} )} & ( 7 )\end{matrix}$$

Where a_{I0′,k}, a_{V′,k}, ψ_{I0′,k}, and ψ_{V′,k} (k=1, 2, 3, 4) are numeric values determined from the results of the data analysis in the procedure for calculating the above-described error correction function by the second calculation unit. According to the present exemplary embodiment, the second calculation unit determines on these numeric values, and the error correction function is calculated.

When each of the first-order measurement target values (I₀′, V′) calculated from the subject data and the first-order phase value (Φ′) are assigned to each of the expressions (6) and (7), it is possible to calculate each of the second-order measurement targets (I₀″, V″). At this time, the value for dividing the distribution of the first-order measurement target value is determined by the first-order phase distribution corresponding to a variable. Thus, the value for dividing the distribution of the first-order measurement target value is changed depending on a position. Furthermore, as compared with a case in which the correction factor is simply determined by the positional coordinates, since the first-order phase value is used as the variable, particularly in the area where the periodic pattern is distorted by the existence of the subject or the like, it is possible to perform the error correction at a still higher accuracy. The values for dividing the first-order measurement target value (to elaborate, denominators in both the expressions) include a value obtained through a cosine of the first-order phase value with the coefficient of 1. According to this, it is possible to correct the error generated at the same period as the fundamental period of the periodic pattern.

When FIGS. 7B and 7D are compared with FIGS. 7A and 7C, the periodic error in FIGS. 7B and 7D is smaller, and it may be understood that the effect of the error derived from the phase shift error or the like is reduced.

### Second Exemplary Embodiment

A second exemplary embodiment is another exemplary embodiment of the first exemplary embodiment mode. Configurations of the X-ray source and the interferometer are similar to those according to the first exemplary embodiment.

The present exemplary embodiment is different from the first exemplary embodiment in that a Fourier transform method is used as the method for the periodic pattern analysis instead of the phase shift method. Since a detail of the Fourier transform method is described in M. Takeda et al. “Fourier-transform method of fringe-pattern analysis for computer-based topography and interferometry”, J. Opt. Soc. Am., Vol. 72, No. 1, 156-160 (1982), a description thereof will be omitted herein.

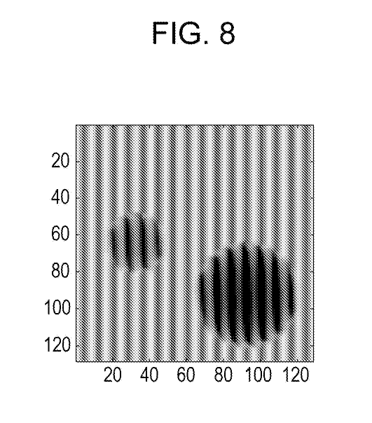

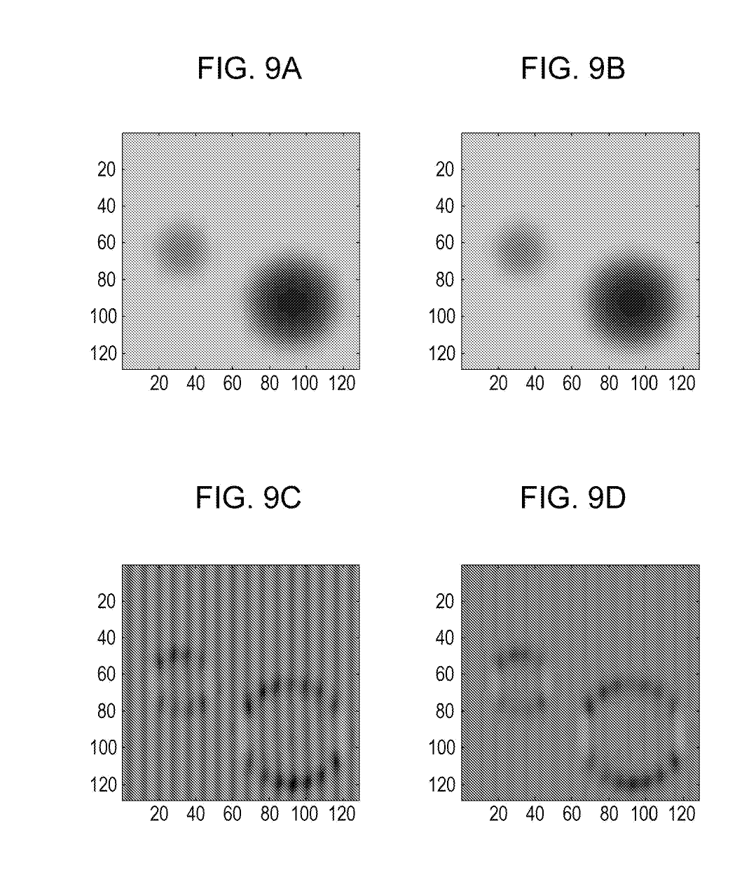

FIG. 8 illustrates a moire used for a simulation according to the present exemplary embodiment. FIGS. 9A and 9C illustrate images of the first-order average detection value I₀′ and the first-order visibility V′ calculated by using the moire of FIG. 8. These images illustrated in FIGS. 9A and 9C are images based on the spatial distribution of the first-order measurement target value, which are based on the spatial distribution calculated by the first calculation unit. FIG. 9A illustrates the image based on the spatial distribution of the first-order average detection value I₀′, and FIG. 9C illustrates the image based on the spatial distribution of the first-order visibility V′. It may be understood that periodic errors are generated in FIGS. 9A and 9C. These periodic patterns are derived from influences of various peaks originally existing in the Fourier spectrum of the moire.

FIGS. 9B and 9D illustrate results of computation processing using the error correction function on FIGS. 9A and 9C corresponding to the images based on the spatial distribution of the first-order measurement target value. To elaborate, FIGS. 9B and 9D illustrate images based on the spatial distribution of the second-order measurement target calculated by the third calculation unit. According to the present exemplary embodiment, the error correction function is calculated by the second calculation unit by using the distribution of the first-order measurement target value and the distribution of the first-order phase value Φ′ in the blank area corresponding to the upper right part of FIG. 8, and the first-order measurement target distribution and the first-order phase distribution are assigned to the error correction function, so that the second-order measurement target distribution is calculated.

In a case where the information of the subject is calculated from the periodic pattern by using the Fourier transform method, an error derived from the zero-order peak in a Fourier spectrum of the periodic pattern, a fundamental frequency peak, or a peak in the vicinity of these peaks may easily be generated. For that reason, according to the present exemplary embodiment, the above-described error is considered as the correction target. In a case also where the Fourier transform method is used, the error can be corrected by dividing the first-order measurement value by a value including a trigonometric function that includes the first-order phase distribution where the coefficient is 1 as the variable. When the second-order average detection value after the error correction is set as I₀″, and the second-order visibility after the error correction is set as V″, for example, the error correction function can be represented by the following expressions (8) and (9).

$$\begin{matrix}{I}_{0}^{″} = \frac{{I}_{0}^{′}}{1 + {a}_{{I}_{0}^{′}} cos ( {Φ}^{′} + {ψ}_{{I}_{0}^{′}} )} & ( 8 ) \\ {V}^{″} = \frac{{V}^{′}}{1 + {a}_{{V}^{′}} cos ( {Φ}^{′} + {ψ}_{{V}^{′}} )} & ( 9 )\end{matrix}$$

Where a_{I0′}, a_{V′}, ψ_{I0′}, and ψ_{V′} are numeric values determined from the results of the data analysis in the procedure for calculating the above-described error correction function by the second calculation unit. According to the Fourier transform method, in general, the phase tilt correction is performed by moving the spectrum in the vicinity of the peak corresponding to the carrier frequency in a Fourier space to the origin. However, with regard to the first-order phase distribution Φ′ used according to the present exemplary embodiment, the phase distribution calculated without performing this spectrum movement, that is, the phase distribution before the tilt correction is performed is to be used.

Similarly as in the first exemplary embodiment, when each of the first-order measurement target values (I₀′, V′) calculated from the subject data and the first-order phase value (Φ′) are assigned to each of the expressions (8) and (9), it is possible to calculate each of the second-order measurement targets (I₀″, V″). At this time, the value for dividing the distribution of the first-order measurement target value is determined by the first-order phase distribution corresponding to the variable. Thus, the value for dividing the distribution of the first-order measurement target value is changed depending on the position. Furthermore, as compared with a case in which the correction factor is simply determined by the positional coordinates, since the first-order phase value is used as the variable, particularly in the area where the periodic pattern is distorted by the existence of the subject or the like, it is possible to perform the error correction at a still higher accuracy. In this manner, by using the error correction function including the first-order phase value as the variable, it is possible to increase the accuracy for correcting the error included in the first-order measurement target value. In addition, the configuration is also similar to the first exemplary embodiment in which the value for dividing the first-order measurement value includes a value obtained through a cosine of the first-order phase value where the coefficient is 1.

When FIGS. 9B and 9D are compared with FIGS. 9A and 9C, the periodic error is smaller in FIGS. 9B and 9D, and it may be understood that the influence of the error derived from the various peaks in the Fourier spectrum of the moire is reduced. In this manner, it is possible to perform the error correction processing also with respect to the analysis result by the Fourier transform method.

### Third Exemplary Embodiment

A third exemplary embodiment is an exemplary embodiment of the second exemplary embodiment mode. Configurations of the X-ray source and the interferometer are similar to the first exemplary embodiment.

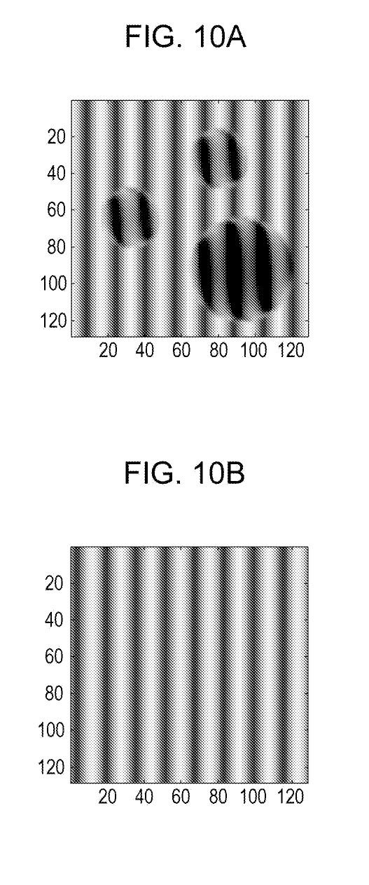

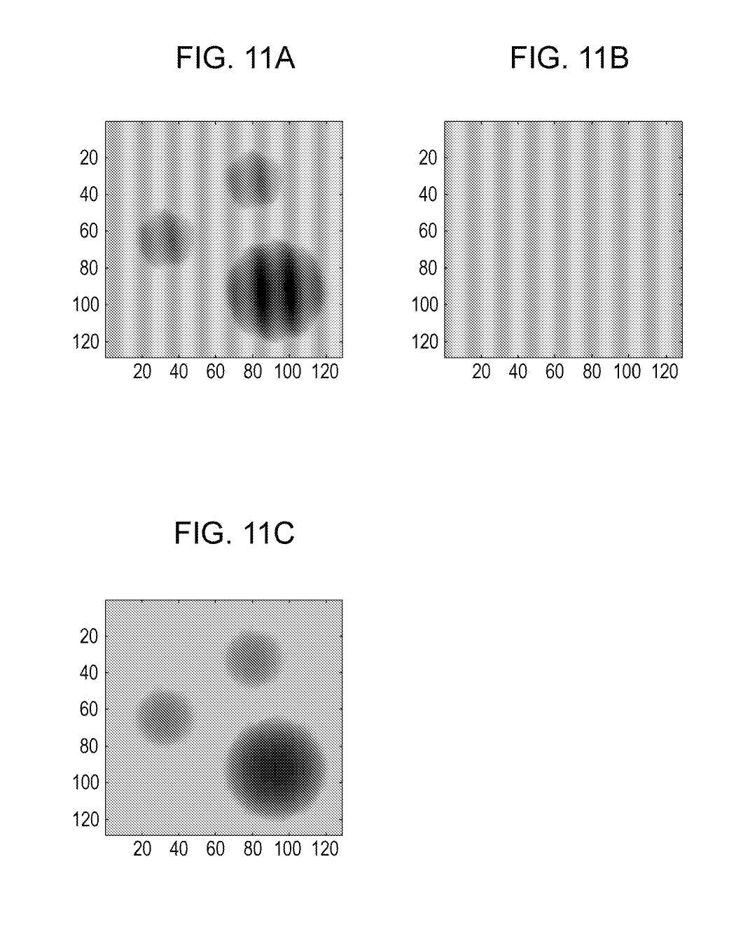

FIGS. 10A and 10B illustrate examples of the subject data and the reference data used for a simulation according to the present exemplary embodiment. Herein, the three-step phase shift method is performed similarly as in the first exemplary embodiment. FIG. 11A illustrates an image of the first-order average detection value I₀′ calculated by using the subject data accompanying three phase shifts in total including FIG. 10A and the expression (3). FIG. 11B illustrates an image of the first-order average detection value I₀′ calculated by using the reference data accompanying three phase shifts in total including FIG. 10B and the expression (3). It is assumed that the relative phase shift errors between the data obtainment performed by three times respectively at the time of obtaining the subject data and at the time of obtaining the reference data are the same. It is however noted that the overall moire phases at the time of respectively obtaining the first data are not matched with each other.

In a case where the average detection value distribution is set as the measurement target distribution, the second calculation unit calculates the error correction function by using the information of the first-order average detection value distribution I₀′ (FIG. 11B) and the first-order phase distribution calculated by using the reference data. A function having the same form as the expression (6) is calculated, and the information of the first-order average detection value distribution I₀′ (FIG. 11A) and the first-order phase distribution calculated by the first calculation unit by using the subject data is assigned to this error correction function, so that the spatial distribution of the second-order average detection value distribution I₀″ is calculated. FIG. 11C illustrates an image based on the calculated spatial distribution of the second-order average detection value distribution I₀″.

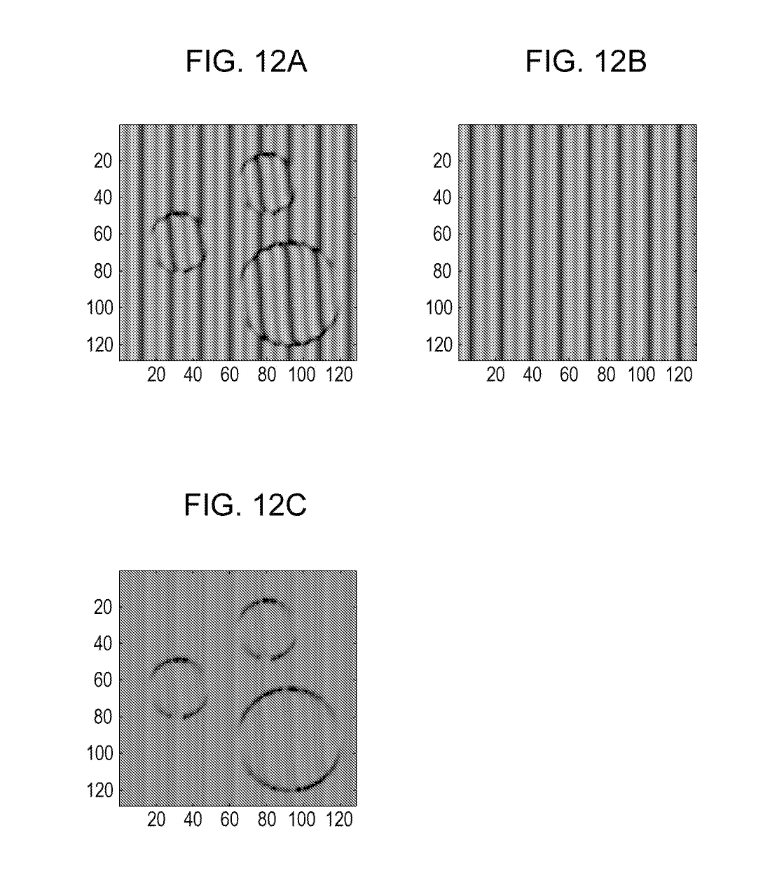

In a case where the visibility distribution is set as the measurement target distribution, the second calculation unit calculates the error correction function by using the information of the first-order visibility distribution V′ and the first-order phase distribution calculated by using the reference data. FIG. 12A illustrates an image based on the spatial distribution of the first-order visibility V′ calculated by using the subject data and the expression (5). Similarly, FIG. 12B illustrates an image based on the spatial distribution of the first-order visibility V′ calculated by the reference data and the expression (5). Similarly as in the case of the above-described I₀′, the error correction function is calculated by using the information of the first-order visibility distribution V′ (FIG. 12B) and the first-order phase distribution calculated by using the reference data. A function having the same form as the expression (7) is calculated, the information of the first-order visibility distribution V′ (FIG. 12A) and the first-order phase distribution calculated by using the subject data is assigned to this error correction function, so that the spatial distribution of the second-order visibility distribution V″ is calculated. FIG. 12C illustrates an image based on the calculated spatial distribution of the second-order visibility distribution V″.

In this manner, in a case where the generation cause of the error has the repeatability, the error can be corrected by using the error correction function calculated from the reference data.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-105457 filed May 17, 2013 and No. 2014-074066 filed Mar. 31, 2014, which are hereby incorporated by reference herein in their entirety.

What is claimed is:

1. A computation apparatus that calculates information of a subject by using subject data,
wherein the subject data is information of a periodic pattern formed by light that has been modulated by the subject, the computation apparatus comprising:
a calculation unit configured to calculate a spatial distribution of a first-order phase value and a spatial distribution of a first-order measurement target value by using the subject data;
a calculation unit configured to calculate an error correction function including the first-order phase value as a variable by using information of the spatial distribution of the first-order measurement target value and the spatial distribution of the first-order phase value; and
a calculation unit configured to calculate information of a spatial distribution of a second-order measurement target value corresponding to a spatial distribution obtained by correcting the spatial distribution of the first-order measurement target value by using the error correction function, the information of the spatial distribution of the first-order phase value, and the information of the spatial distribution of the first-order measurement target value,
wherein the spatial distribution of the first-order measurement target value is at least one of a distribution of an average detection value and a visibility distribution of the subject data.

2. The computation apparatus according to claim 1,
wherein the calculation unit configured to calculate the error correction function calculates the error correction function from information of the first-order measurement target value and the first-order phase value in an area of the periodic pattern formed by light that has not been modulated by the subject among the subject data.

3. A computation apparatus that calculates information of a subject by using subject data and reference data,
wherein the subject data is information of a periodic pattern formed by light that has been modulated by the subject, and
wherein the reference data is information of a periodic pattern formed by light that has not been modulated by the subject, the computation apparatus comprising:
a calculation unit configured to calculate a spatial distribution of a first-order measurement target value and a spatial distribution of a first-order phase value by using the reference data;
a calculation unit configured to calculate a spatial distribution of a first-order measurement target value and a spatial distribution of a first-order phase value by using the subject data;
a calculation unit configured to calculate an error correction function including a first-order phase value of the periodic pattern as a variable by using information of the spatial distribution of the first-order measurement target value and the spatial distribution of the first-order phase value calculated by using the reference data; and
a calculation unit configured to calculate a distribution of a second-order measurement target value corresponding to a distribution obtained by correcting the spatial distribution of the first-order measurement target value calculated by using the subject data, by using the error correction function and the information of the spatial distribution of the first-order phase value and the information of the spatial distribution of the first-order measurement target value calculated by using the subject data,
wherein the spatial distribution of the first-order measurement target value is at least one of a distribution of an average detection value and a distribution of a visibility of the subject data.

4. The computation apparatus according to claim 1,
wherein when the first-order phase value of the subject data is set as Φ′, and A and α are set as a constant, the error correction function has a term that can be represented as A sin(Φ′+α).

5. The computation apparatus according to claim 3,
wherein when the first-order phase value of the subject data is set as Φ′, and A and α are set as a constant, the error correction function has a term that can be represented as A sin(Φ′+α).

6. The computation apparatus according to claim 1,
wherein the calculation unit configured to calculate the spatial distribution of the first-order phase value and the spatial distribution of the first-order measurement target value by using the subject data calculates the spatial distribution of the first-order phase value and the spatial distribution of the first-order measurement target value from a change in a detection value between plural pieces of the subject data, and
wherein a phase of the periodic pattern is shifted between the plural pieces of the subject data.

7. The computation apparatus according to claim 3,
wherein the calculation unit configured to calculate the spatial distribution of the first-order phase value and the spatial distribution of the first-order measurement target value by using the subject data calculates the spatial distribution of the first-order phase value and the spatial distribution of the first-order measurement target value from a change in a detection value between plural pieces of the subject data, and
wherein a phase of the periodic pattern is shifted between the plural pieces of the subject data.

8. An image pickup system comprising:
an image pickup apparatus including a detector configured to detect a periodic pattern; and
a computation apparatus configured to calculate information of a subject by using subject data detected by the detector,
wherein the detector detects the subject data by detecting the periodic pattern on the detector when the subject is arranged in an optical path between a light source and the detector, and
wherein the computation apparatus is the computation apparatus as described in claim 1.

9. An image pickup system comprising:
an image pickup apparatus including a detector configured to detect a periodic pattern; and
a computation apparatus configured to calculate information of a subject by using subject data detected by the detector,
wherein the detector detects the subject data by detecting the periodic pattern on the detector when the subject is arranged in an optical path between a light source and the detector, and
wherein the computation apparatus is the computation apparatus as described in claim 3.

10. The image pickup system according to claim 8,
wherein a period of the periodic pattern is shorter than a width of a detection range of the detector.

11. The image pickup system according to claim 9,
wherein a period of the periodic pattern is shorter than a width of a detection range of the detector.

12. The image pickup system according to claim 8,
wherein the image pickup apparatus includes a light source and an optical element configured to form a periodic pattern by light output from the light source.

13. The image pickup system according to claim 9,
wherein the image pickup apparatus includes a light source and an optical element configured to form a periodic pattern by light output from the light source.

14. The image pickup system according to claim 12,
wherein the light source is an X-ray source,
wherein the optical element is an X-ray optical element configured to form a periodic pattern by X-ray output from the X-ray source, and
wherein the detector is an X-ray detector configured to detect X-ray from the optical element.

15. The image pickup system according to claim 13,
wherein the light source is an X-ray source,
wherein the optical element is an X-ray optical element configured to form a periodic pattern by X-ray output from the X-ray source, and
wherein the detector is an X-ray detector configured to detect X-ray from the optical element.

16. A storage medium storing a program for calculating information of a subject by using subject data corresponding to information of a periodic pattern formed by light that has been modulated by the subject, the program causing a computation apparatus to execute
calculating a spatial distribution of a first-order phase value and a spatial distribution of a first-order measurement target value by using the subject data,
calculating an error correction function including the first-order phase value as a variable by using information of the spatial distribution of the first-order measurement target value and the spatial distribution of the first-order phase value, and
calculating a distribution of a second-order measurement target value corresponding to a distribution obtained by correcting the spatial distribution of the first-order measurement target value by using the error correction function, a distribution of the first-order phase value, and a distribution of the first-order measurement target value,
wherein the spatial distribution of the first-order measurement target value is at least one of a spatial distribution of an average detection value and a spatial distribution of a visibility of the subject data.

17. A storage medium storing a program for calculating information of a subject by using subject data corresponding to information of a periodic pattern formed by light that has been modulated by the subject and reference data corresponding to information of a periodic pattern formed by light that has not been modulated by the subject, the program causing a computation apparatus to execute
calculating a spatial distribution of a first-order phase value and a spatial distribution of a first-order measurement target value by using the reference data,
calculating a spatial distribution of a first-order phase value and a spatial distribution of a first-order measurement target value by using the subject data,
calculating an error correction function including a first-order phase value of a periodic pattern as a variable by using information of the spatial distribution of the first-order measurement target value and the spatial distribution of the first-order phase value of the reference data, and
calculating a distribution of a second-order measurement target value corresponding to a distribution obtained by correcting the spatial distribution of the first-order measurement target value calculated by using the subject data, by using the error correction function and the spatial distribution of the first-order phase value and the spatial distribution of the first-order measurement target value calculated by using the subject data,
wherein the spatial distribution of the first-order measurement target value is at least one of a spatial distribution of an average detection value and a spatial distribution of a visibility of the subject data.
